(19) United States
(12) Patent Application Publication
(10) Pub. No.: US 2013/0125648 A1
(43) Pub. Date: May 23, 2013

(54) CENTRIFUGE IMBALANCE SENSOR AND NON-CONTACT SPECIMEN CONTAINER CHARACTERIZATION

(71) Applicant: Beckman Coulter, Inc., Brea, CA (US)

(72) Inventors: Ed MURASHIE, Fullerton, CA (US); Mark GROSS, Laguna Niguel, CA (US); Santiago ALLEN, Yorba Linda, CA (US); Allan TROCHMAN, Corona, CA (US)

(73) Assignee: Beckman Coulter, Inc., Brea, CA (US)

(21) Appl. No.: 13/671,312

(22) Filed: Nov. 7, 2012

Related U.S. Application Data
(60) Provisional application No. 61/556,667, filed on Nov. 7, 2011.
(60) Provisional application No. 61/616,994, filed on Mar. 28, 2012.
(60) Provisional application No. 61/680,066, filed on Aug. 6, 2012.

(51) Int. Cl. G01M 1/14; G01B 11/02; G01N 21/27; G01B 11/10; G01B 11/08

(52) U.S. Cl. CPC G01M 1/14; G01B 11/10; G01B 11/08; G01N 21/27; G01B 11/02
USPC 73/460; 356/634; 356/73

(57) ABSTRACT

A system and method for non-contact specimen container characterization includes a processor, and a specimen container diameter sensor, and a specimen container length sensor. The non-contact specimen container can also include a cap color sensor. The sensors are located in a fixed position relative to a conveyor for transporting a plurality of specimen containers.

Another embodiment is directed to a system and method for detecting centrifuge imbalance along multiple axes. First, second and third comparators compare an accelerometer output corresponding to x-, y- and z-axes with reference voltage levels. The outputs are used to determine whether to discontinue operation of the centrifuge. The outputs can also be used to generate alerts.

### CROSS-REFERENCES TO RELATED APPLICATIONS

This application claims priority to U.S. Provisional Patent Application No. 61/556,667, filed Nov. 7, 2011 and entitled “Analytical System and Method for Processing Samples,” herein incorporated by reference in its entirety for all purposes. This application also claims priority to U.S. Provisional Patent Application No. 61/616,994, filed Mar. 28, 2012 and entitled “Analytical System and Method for Processing Samples,” herein incorporated by reference in its entirety for all purposes. This application further claims priority to U.S. Provisional Patent Application No. 61/680,066, filed Aug. 6, 2012 and entitled “Analytical System and Method for Processing Samples,” herein incorporated by reference in its entirety for all purposes.

### BACKGROUND

A specimen transport system may be used to convey specimens within a laboratory analysis system. Specimens may be samples of blood or other bodily fluids on which laboratory analysis is to be performed. Preparation of a sample for analysis may require transporting the sample to various stations for aliquotting, centrifuging, or other processes. The sample may then be transported to a location where analysis is to be performed and to an output station for storage or disposal. Various transportation systems may be used to transport samples between stations of a laboratory analysis system.

A conveyor transport system may use a conveyor belt or conveyor track to transport sample tubes between stations. Typically, a sample tube is inserted into a sample carrier that holds the specimen in a fixed upright position for transport by the conveyor system. The sample carrier may be configured to receive one or more sample tubes.

A sample tube may require centrifuging prior to analysis. Sample tubes may be inserted into a centrifuge adapter for centrifuging. One or more centrifuge adapters may be placed in the centrifuge. When sample tubes or centrifuge adapters having varying weights are loaded into a centrifuge, the centrifuge may wobble due to imbalance.

Centrifuges may use imbalance sensors to determine when a centrifuge is experiencing imbalance. Centrifuges typically have some tolerance for imbalance. However, if imbalance occurs in excess of a centrifuge's imbalance tolerance, samples may be damaged or destroyed. An imbalance sensor may be used to discontinue the spinning of a centrifuge rotor in the case that the imbalance of a centrifuge exceeds the centrifuge's imbalance tolerance.

Conventional centrifuge imbalance sensors use contact switch based imbalance sensing or optical switch based imbalance sensing to determine when sample volume imbalance exceeds a centrifuge's imbalance tolerance. In contact switch based imbalance sensing, imbalance is indicated when a containment vessel of a centrifuge contacts a contact switch. Contact switches must be mechanically adjusted for the tolerance of a particular centrifuge and may be damaged by impact with the containment vessel in the case of large imbalances. In optical switch based imbalance sensing, a flag attached to a containment vessel breaks an optical beam. Contaminants interrupting the beam can interfere with the functionality of optical switch imbalance sensing. Existing contact switch and optical switch based imbalance sensors are limited to sensing displacement of a containment vessel in one dimension.

Embodiments of the invention solve these and other problems.

### BRIEF SUMMARY

Embodiments of the technology relate to systems and methods for efficiently processing samples collected for laboratory analysis. More specifically, a system and method for obtaining information about specimen containers using fixed sensors are described. A system and method for sensing centrifuge imbalance are also described.

One embodiment is directed to a system for non-contact specimen container characterization. The system for non-contact specimen container characterization includes a processor and a specimen container diameter sensor and a specimen container length sensor communicatively coupled to the processor. The specimen container diameter sensor includes a horizontally oriented linear optical array. The specimen container length sensor includes a vertically oriented linear optical array. The specimen container diameter sensor and the specimen container length sensor are located in a fixed position relative to a conveyor for transporting a plurality of specimen containers.

In some embodiments, the non-contact specimen container characterization further includes a cap color sensor that is communicatively coupled to the processor. The cap color detector includes a light to frequency converter.

Another embodiment is directed to a method for non-contact specimen characterization. The method includes receiving a first signal from a specimen container diameter sensor at a processor. A second signal is received by the processor form a specimen container length sensor. A specimen container diameter is determined based on the first signal and a specimen container length is determined based on the second signal.

A further embodiment is directed to an imbalance sensor for detecting centrifuge imbalance. The imbalance sensor includes an accelerometer that is coupled to a centrifuge containment vessel. A comparator is configured to compare an accelerometer output with a reference voltage level. A switch receives an output form the comparator. The rotation of the centrifuge is discontinued based on the output of the switch.

An additional embodiment is directed to an imbalance sensor for detecting centrifuge imbalance along multiple axes. The imbalance sensor includes an accelerometer that is coupled to a centrifuge containment vessel. A first comparator is configured to compare an accelerometer output corresponding to a first axis with a first voltage level. A second comparator is configured to compare an accelerometer output corresponding to a second axis with a second voltage level.

Another embodiment is directed to a method for detecting centrifuge imbalance along multiple axes. The method includes coupling an accelerometer to a centrifuge containment vessel. A first comparator compares an accelerometer output corresponding to a first axis with a first voltage level. A second comparator compares an accelerometer output corresponding to a second axis with a second voltage level. A third comparator compares an accelerometer output corresponding to a third axis with a third voltage level. A summing comparator compares a sum of the outputs from the first comparator, the second comparator and the third comparator to a fourth voltage level. If the sum of the outputs exceed the fourth voltage level, the rotation of a centrifuge is discontinued

These and other embodiments of the technology are described in further detail below.

### BRIEF DESCRIPTION OF THE DRAWINGS

A further understanding of the nature and advantages of the different embodiments may be realized by reference to the following drawings.

FIG. 1 depicts a block diagram of components associated with phases of a laboratory automation system.

FIG. 2 depicts an illustrative top view of a non-contact specimen container characterization system.

FIG. 3 depicts an illustrative sample carrier with cutouts to allow optical access to the specimen container.

FIGS. 4(a)-4(c) show illustrative side views of the specimen container sensors of a non-contact specimen container characterization system.

FIG. 5 is an illustrative block diagram for a non-contact specimen container characterization system.

FIG. 6 shows a flow diagram for a non-contact specimen container characterization system.

FIG. 7A depicts an illustrative system diagram of an accelerometer-based centrifuge imbalance sensor.

FIGS. 7B-7C show an illustrative centrifuge.

FIG. 8 depicts a circuit diagram of an accelerometer-based centrifuge imbalance sensor.

FIG. 9 depicts a flow diagram of an accelerometer-based centrifuge imbalance sensor.

FIG. 10 depicts a block diagram of an exemplary computer apparatus.

### DETAILED DESCRIPTION

An automated system for processing specimens for laboratory analysis may include a conveyance device to transport the specimens between laboratory modules. For example, a specimen may require aliquotting and/or centrifuging before the specimen is analyzed. It may be beneficial to determine one or more physical characteristics of a specimen container with a sensor system that is in a fixed position relative to the specimen container. For example, the sensor system may be installed in a fixed position relative to a system for transporting specimen containers, such as a conveyor belt.

When specimens are loaded into a centrifuge, imbalance may occur during the centrifuge process due to varying weights of the specimen containers in the centrifuge. If the centrifuge exceeds the imbalance tolerance of the centrifuge, it may be desirable to halt the centrifuge process. An accelerometer based imbalance sensor can be used to sense imbalance along multiple axes.

Embodiments of a non-contact specimen container characterization system and accelerometer based centrifuge imbalance sensor are discussed in more detail below.

### I. Non-Contact Specimen Container Characterization

Physical characteristics of a specimen container may be determined using one or more sensors that are fixed relative to a specimen transport system. For example, it may be desirable to determine physical characteristics of a specimen container as the specimen container is transported between stations of a laboratory analysis system. A non-contact specimen container characterization system may be capable of determining various physical characteristics of a specimen container with no contact between the sensor devices and the specimen container. In comparison with a specimen container characterization system that picks up a specimen or otherwise requires contact with the specimen container to determine characteristics of the specimen container, a non-contact specimen container characterization system may obtain information about the specimen container in a relatively time-efficient manner, allowing for rapid specimen processing. Additionally, non-contact specimen container characterization system can determine characteristics of a specimen container without disturbing the position of the container. This may be beneficial for systems in which position of specimen containers in a queue is related to the order in which specimen containers are scheduled to be processed.

Physical characteristics such as specimen container diameter and specimen container length may be determined by the non-contact specimen container characterization system. The color of a cap for a specimen container may also be determined. In some embodiments, liquid level determinations may be performed by a non-contact specimen characterization system.

A specimen container may be transported by a transport system such as a conveyor transport system, a self-propelled puck transport system, a magnetic transport system, or other transport system. A conveyor transport system may include a conveyor, such as a conveyor belt or track, for transporting specimens.

The specimen container may be a sample tube used to contain samples of blood or other fluids for laboratory analysis. One or more specimen containers may be inserted into a sample carrier for transport by a conveyor transport system or other transport system. For example, a sample carrier placed on a conveyor belt may be carried by the movement of the belt.

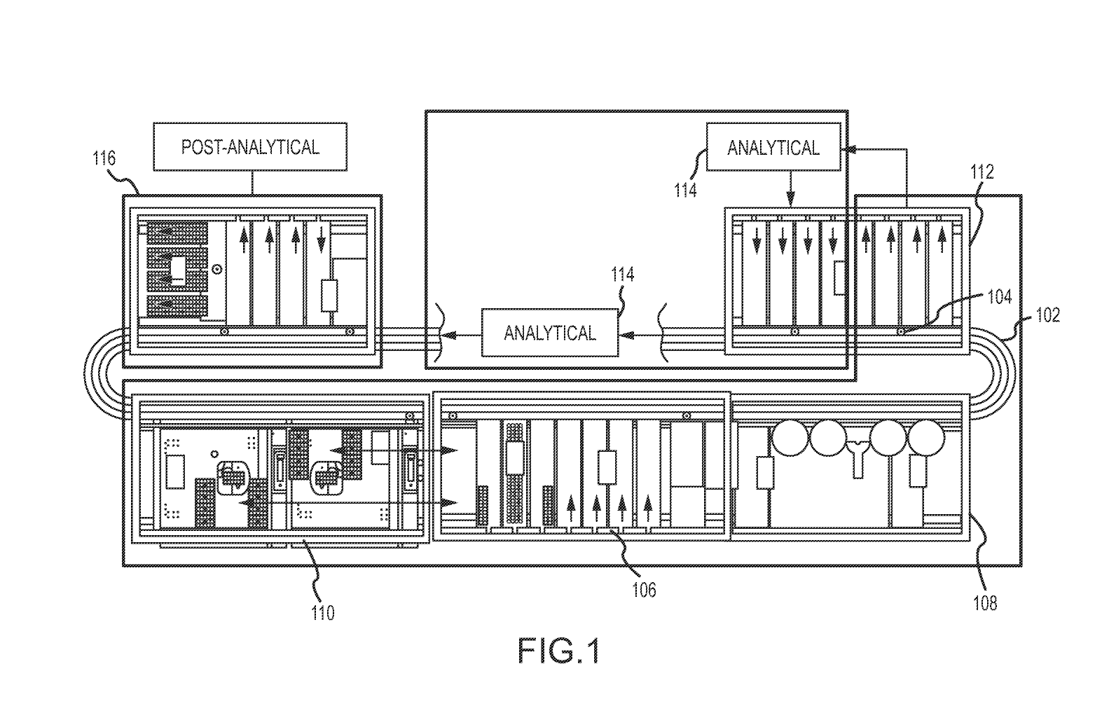

FIG. 1 shows an illustrative embodiment of a conveyor system used to transport sample carriers in a laboratory automation system for processing patient samples. The laboratory automation system may use a conveyor track to transport sample carriers between various areas of the laboratory automation system. For example, conveyor track 102 may be used to transport sample carriers 104 between one or more of, e.g., a specimen container input and distribution area 106, an aliquotter area 108, a centrifuge area 110, an output area 112, analytical areas 114, and a post-analytical sample processing area 116.

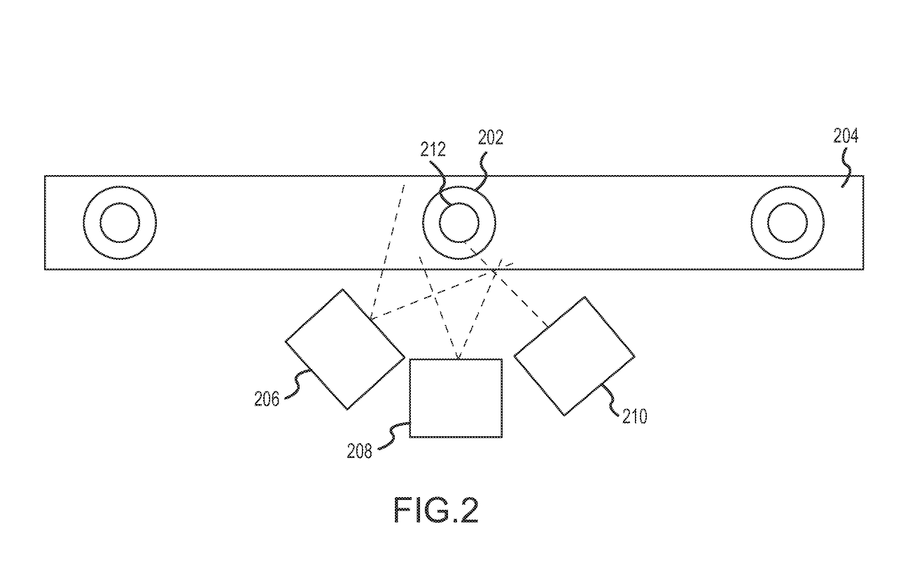

FIG. 2 is an illustrative top view of a non-contact specimen container characterization system. Sample carrier 202 is shown on a conveyor 204. Same carrier 202 may be configured to hold one or more specimen containers 212. One or more sensors, such as specimen container diameter sensor 206, cap color sensor 208, and specimen container height sensor 210 are fixed relative to conveyor 204. For example, sensors 206-210 may be coupled to a supporting structure or sidewall of conveyor 204. Conveyor 204 may be a conveyor belt, conveyor track, or other surface for transporting specimens. In other embodiments, sensors 206-210 may be located in a fixed position and specimen containers are manually transported to the sensors or otherwise become located in the sensor range without a conveyor.

In some embodiments, sensors 206, 208 and 210 are able to determine physical characteristics associated with the specimen container 202 as the specimen container 202 is moved by the conveyor belt 204. In alternative embodiments, conveyor belt 204 is configured to stop when sample tube 212 is at a position at which sensors 206, 208 and 210 are able to determine physical characteristics of sample tube 202.

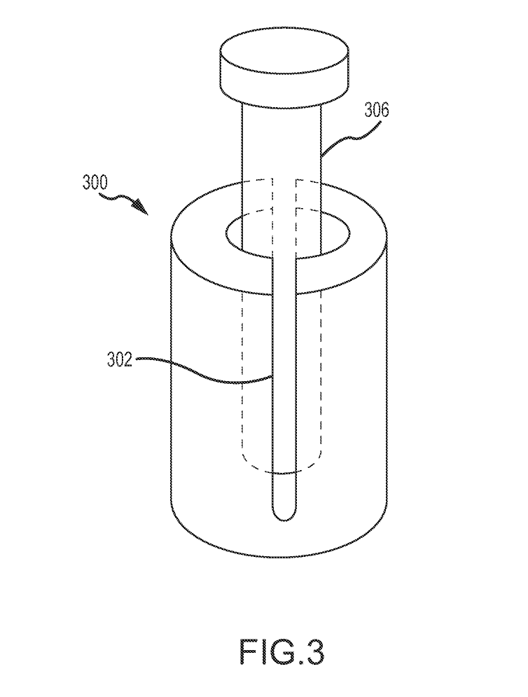

FIG. 3 shows an illustrative sample carrier with cutouts to allow optical access to the specimen container. A sample carrier 300 used to transport a specimen container 306 may have one or more slots 302 to allow specimen container 306 to be visible to the non-contact specimen container characterization system. Slots 302 may have a vertical orientation to allow the length of specimen container 306 to be determined while the specimen container is held upright within specimen carrier 300.

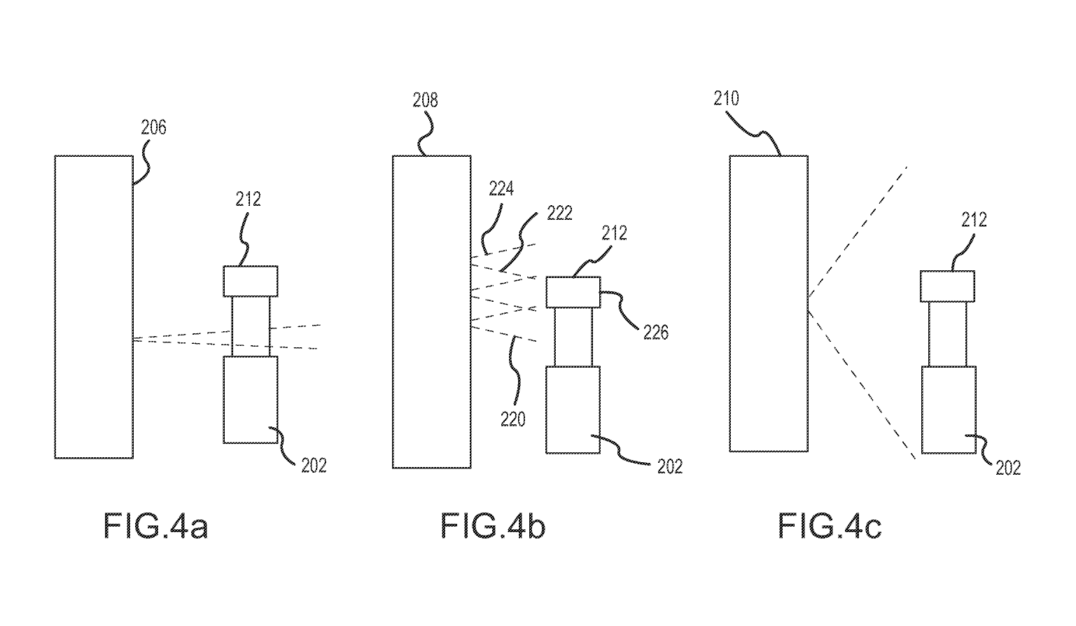

FIGS. 4(a)-4(c) show illustrative side views of the specimen container sensors depicted in FIG. 3. FIG. 4(a) shows specimen container diameter sensor 206. Specimen container diameter sensor 206 can have a light detector that is horizontally oriented (as indicated by the dotted lines originating at diameter sensor 206). The light detector of diameter sensor 206 can be a linear optical array having a plurality of photodiodes (i.e., pixels) arranged horizontally. For example, a linear array having 5-1000 pixels, such as 50-300 pixels, e.g., 100 pixels, may be used. In an exemplary embodiment, a TAOS TSL3301-LP linear array can be used. Each photodiode can produce a photocurrent proportional to an amount of light incident on the photodiode. The diameter of specimen container 212 can be determined based on the output of the linear optical array of diameter sensor 206. For example, if specimen container 212 is located between a light source and the linear optical array, a number of photodiodes on which a relatively low amount of light is incident (e.g., a number of photodiodes producing a photocurrent below a threshold level) may correspond to the diameter of the specimen container.

FIG. 4(b) shows specimen container cap color sensor 208. Specimen container cap color sensor 208 may comprise one or more color sensors for determining a color of a cap on specimen container 212. The color sensor is configured to sense an area aligned with the cap of specimen container 212. Multiple cap color sensors 220, 222 and 224 are illustrated by the dotted lines in FIG. 4(b). Specimen container 212 shown in FIG. 4(b) has cap 226 that is aligned with cap color sensor 222. For a specimen container that is taller than the specimen container 212 as shown, cap color sensor 224 may be used. Similarly, for a specimen container that is shorter than the specimen container 212 as shown, cap color sensor 220 may be used. A color sensor of cap color sensor 4108 may be TAOS 230D light-to-frequency converter. Alternatively, the color sensor may be a camera such as a CCD camera. The color of cap 226 may be determined based on the output of the color sensor. A camera may further be used to read a barcode or other label attached to specimen container 212.

FIG. 4(c) shows a specimen container length sensor 210. The length sensor 210 can have a light detector that is vertically oriented (as indicated by the dotted line originating at length sensor 210). For example, the light detector of length sensor 210 can be a linear optical array (e.g., a TAOS TSL3301-LP linear array) having a plurality of photodiodes (i.e., pixels) arranged in a linear array similar to the linear optical array described with reference to diameter sensor 206. The length of specimen container 212 (e.g., from the bottom of the tube to the top of the cap) can be determined based on the output of the linear optical array of length sensor 210. In some embodiments, length sensor 210 may be used to detect the liquid level of one or more liquid types in specimen container 212.

In some embodiments, a sensor is used to determine whether specimen container 212 is in a position at which physical characteristics of specimen container 212 can be determined. For example, the output of specimen container length sensor 210 may be used to determine whether specimen container 212 is in a position at which cap color sensor 208 can determine the cap color of specimen container 212.

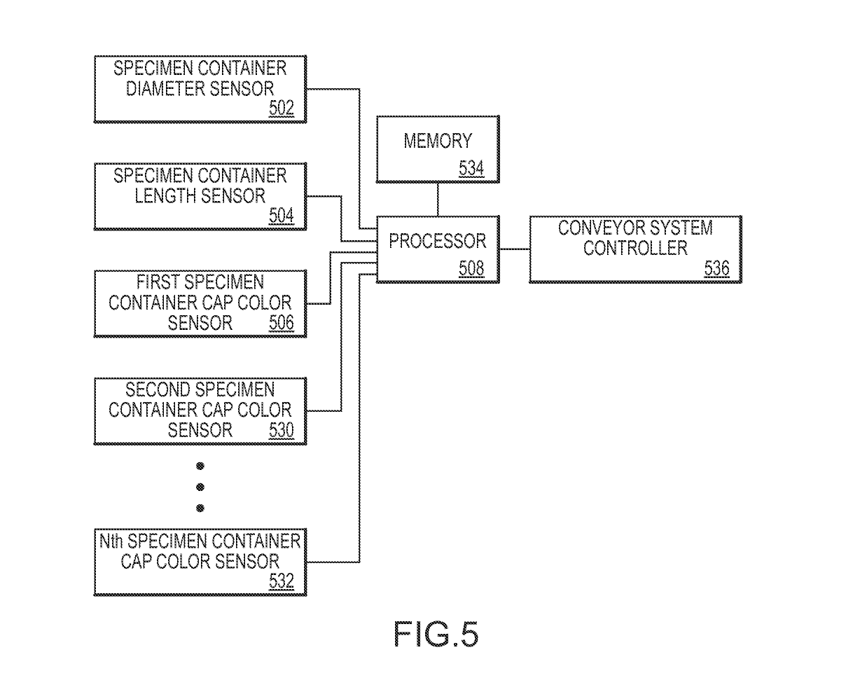

FIG. 5 is an illustrative block diagram for a non-contact specimen container characterization system. Specimen container diameter sensor 502 (corresponding to diameter sensor 206 of FIG. 2) and specimen container length sensor 504 (corresponding to length sensor 210 of FIG. 2) may be communicatively coupled to processor 508. Processor 508 may be a processor of a conveyor control system, a processor of a laboratory automation system, or a processor of another system or computer. One or more cap color sensors, such as a first cap color sensor 506 and second cap color sensor 530 through an Nth cap color sensor 532 (all corresponding to cap color sensor 208 of FIG. 2), may also be communicatively coupled to the processor. In one embodiment, processor 508 may receive a signal from specimen container length sensor 504 indicating the length of specimen container 212. Based on the signal received from specimen container length sensor 504, processor 508 may execute instructions to determine which of specimen container cap color sensors 506, 530, 532 to use for sensing the color of cap 226.

In various embodiments, a conveyor system controller 536 may be communicatively coupled to processor 508. Conveyor system controller 536 may be a processor that generates signals to drive a conveyor motor, such as a conveyor motor associated with a conveyor belt 510. Alternatively, conveyor system controller 536 may be a motor associated with a conveyor belt 510. Processor 508 may receive a signal from one or more of diameter sensor 502, length sensor 504, and/or cap color sensors 506, 530, 532 and processor 508 may execute instructions to determine when a specimen container 212 is in a position at which its physical characteristics can be determined, based on the received signal or signals. When the specimen container 212 is in a position at which its physical characteristics can be determined, the processor 508 may generate a signal instructing conveyor system controller 536 to halt the motion of the conveyor. In this manner, a conveyor belt is stopped each time a specimen container 212 is aligned with the characterization sensors.

Instructions executed by the processor 508 may be stored on processor 508 or may be stored in a memory 534 accessible by processor 508.

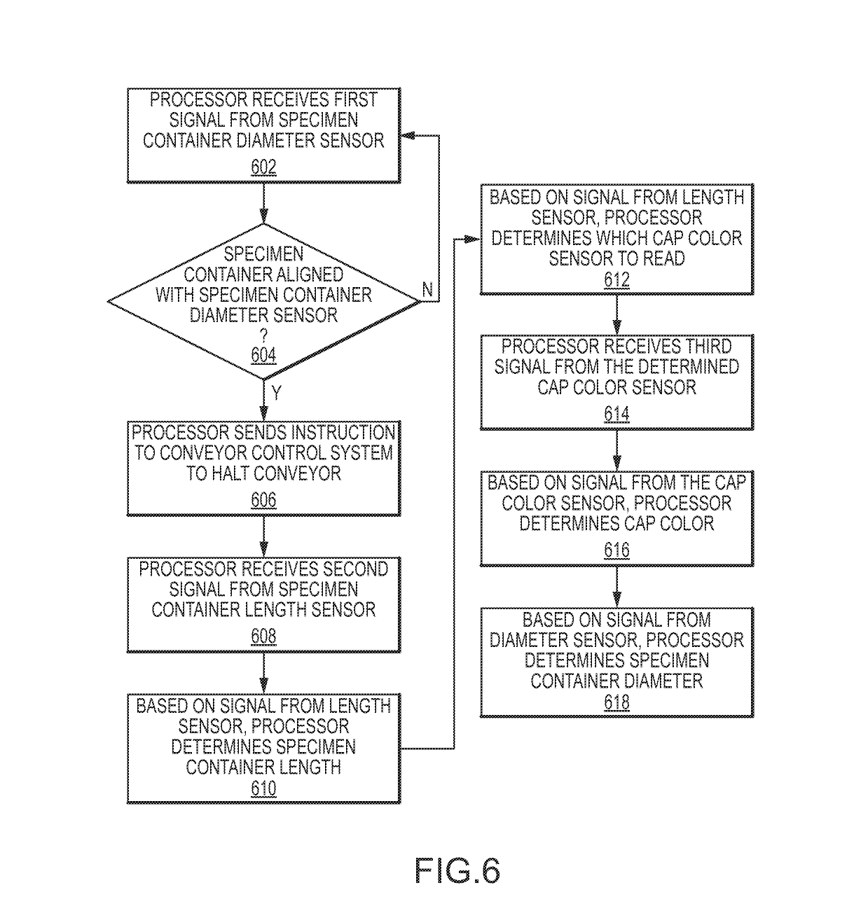

FIG. 6 is a flow diagram for a non-contact specimen container characterization system. At operation 602, a processor 508 can receive a first signal from a specimen container diameter sensor 502. Based on the received signal, the processor 508 can determine whether a specimen container 212 is aligned with specimen container diameter sensor such that a diameter can be determined, as indicated at decision diamond 604. If specimen container 212 is aligned with diameter sensor 502, processor 508 may generate an instruction to halt a conveyor system. For example, processor 508 may generate an instruction to halt a conveyor system when a signal received from diameter sensor 502 indicates that a light level has fallen below a threshold level for a predetermined number of photodiodes of a linear optical array. In another example, processor 508 may generate an instruction to halt a conveyor system after a delay starting from when a signal received from diameter sensor 502 indicates that a light level has fallen below a threshold level for a predetermined number of photodiodes of a linear optical array. In alternative embodiments, processor 508 can determine a specimen container diameter, specimen container length and cap color without halting the conveyance system. The physical characteristics may be determined after a delay starting at a point in time when diameter sensor 502 or another sensor first detects the presence of a specimen container 212.

At operation 608, processor 508 receives a second signal from specimen container length sensor 504. Based on the second signal, processor 508 can determine the length of the specimen container 212, as indicated at operation 610. At operation 612, processor 508 can determine which of cap color sensors 506, 530, 532 to use for determining the color of cap 226. At operation 614, processor 508 receives a third signal from the cap color sensor determined at operation 612. Based on the signal from the cap color sensor determined at operation 612, processor 508 can determine the cap color of cap 226.

In some embodiments, processor 508 may receive a signal from diameter sensor 502 after the conveyor has been halted. Based on the signal received from diameter sensor 502, processor 508 can determine the diameter of specimen container 212.

After the physical characteristics of a specimen container have been determined, the specimen container may proceed to a centrifuge module for centrifugation. The physical characteristics of the specimen container can be performed after centrifugation.

### II. Accelerometer Based Centrifuge Imbalance Sensor

A centrifuge may include an imbalance sensor to prevent excessive imbalance of the centrifuge. An accelerometer based imbalance sensor may be used to determine when centrifuge imbalance is occurring in excess of the imbalance tolerance of a centrifuge.

The accelerometer based imbalance sensor may sense acceleration of a centrifuge containment vessel along one, two, or three axes. Sensing along three axes may provide a level of detail about the imbalance occurring in a centrifuge to allow monitoring for early wear of shock mounting structures or other mechanical components of a centrifuge. Determining imbalance based on acceleration (i.e. “g force”) may provide a more accurate indication than is available from displacement based sensing techniques.

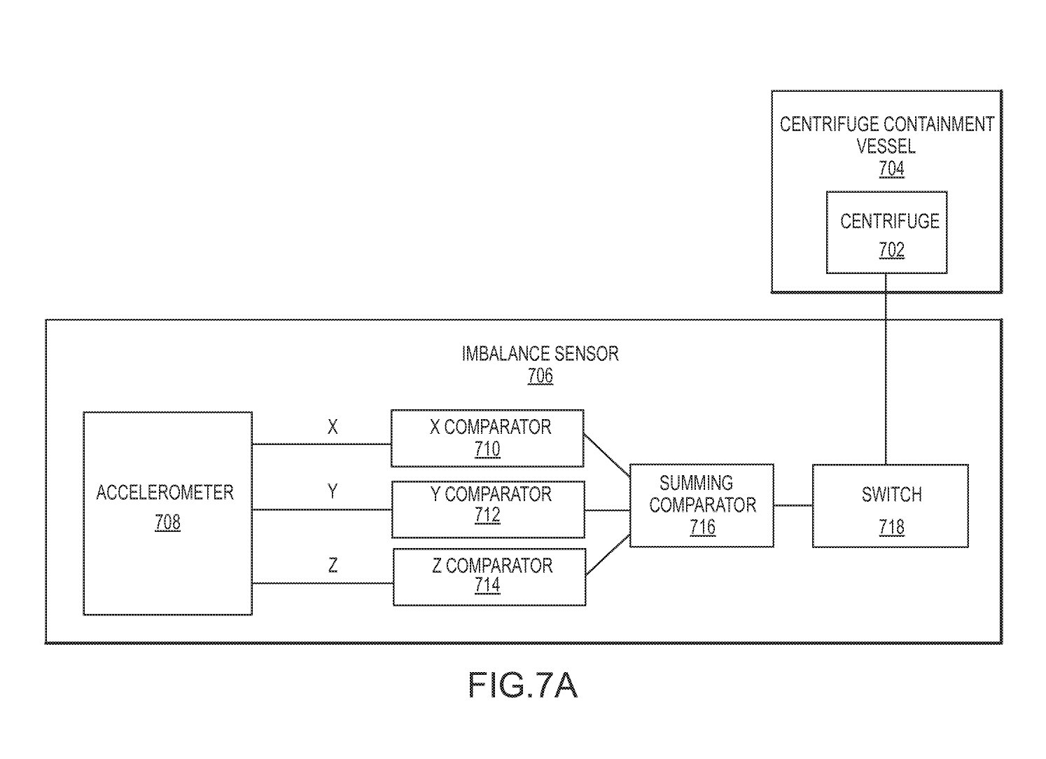

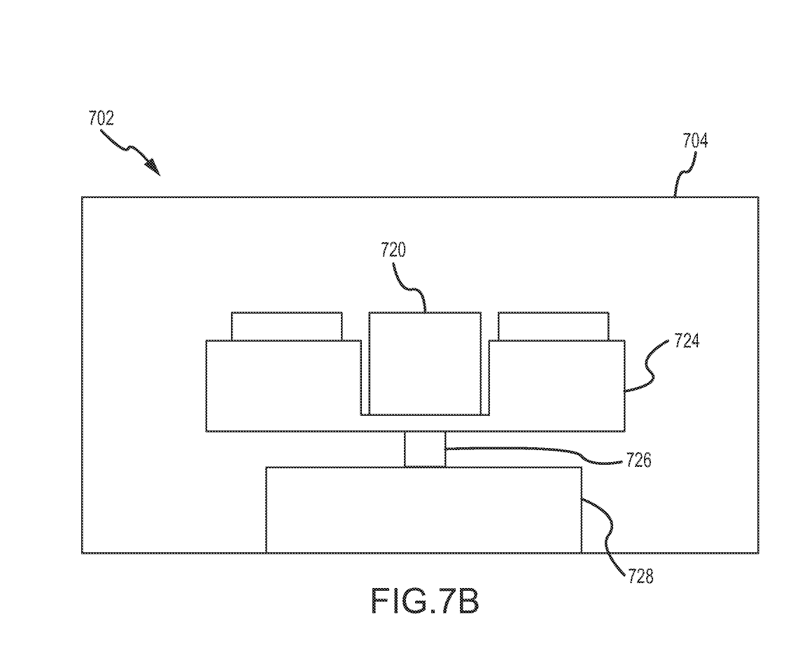

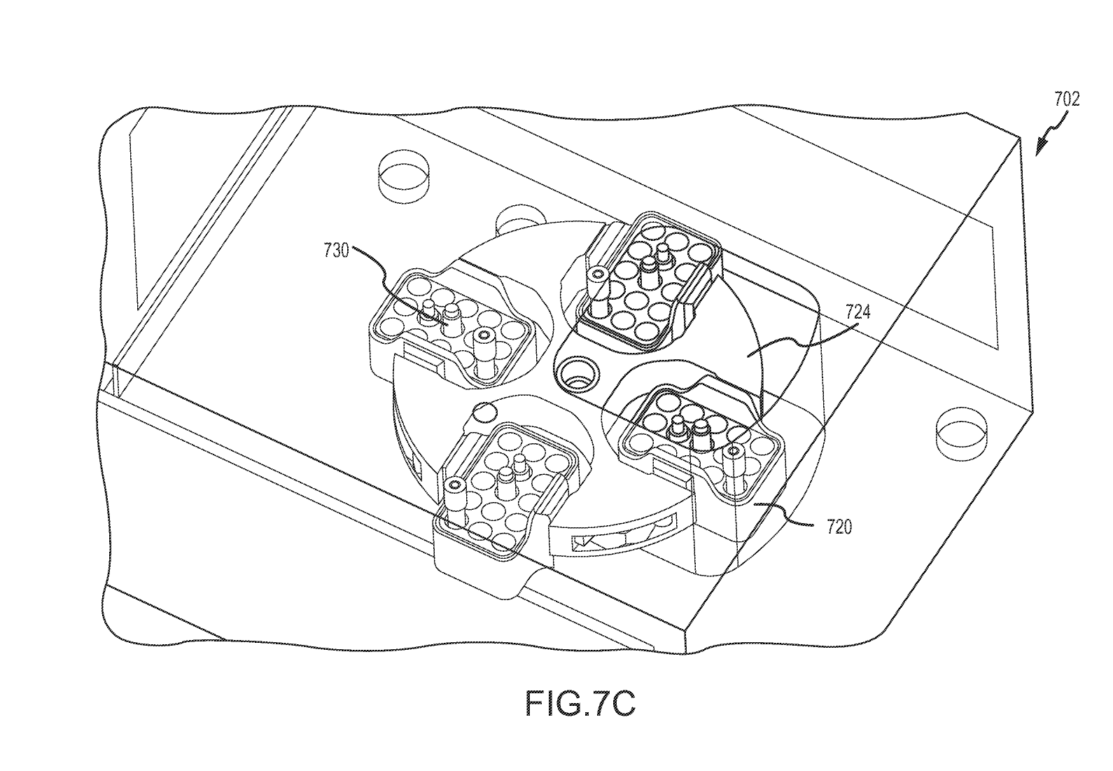

An illustrative system diagram of an accelerometer based centrifuge imbalance sensor is depicted in FIG. 7A. Centrifuge 702 may be mounted within centrifuge containment vessel 704. Accelerometer 708 of imbalance sensor 706 may be directly or indirectly mechanically coupled to a component of centrifuge 702. For example, accelerometer 708 may be mechanically coupled to centrifuge containment vessel 704 such that acceleration is transmitted from the surface of centrifuge containment vessel 704 to accelerometer 708. In another example, accelerometer 708 may be mounted on a printed circuit board (PCB) that is mechanically coupled to the centrifuge containment vessel 704. In other embodiments, accelerometer 708 may be mounted to another element of centrifuge 702, such as on or within the centrifuge rotor, shaft, or motor.

FIG. 7B shows an illustrative cross sectional view of a centrifuge. Centrifuge 702 can include centrifuge containment vessel 704. Within centrifuge containment vessel 704, motor 728 drives rotor 726 via shaft 726. Rotor 726 may have one or more centrifuge buckets 720. A centrifuge adapter 730 may be inserted into each centrifuge bucket 720. Centrifuge adapters may have one or more specimen containers containing medical samples. An illustrative perspective view of the centrifuge is shown in FIG. 7C.

Accelerometer 708 may be a single- or multi-axis device capable of generating a signal corresponding to the acceleration of an object to which the accelerometer is mechanically coupled. The accelerometer may have piezoelectric, piezoresistive, capacitive or other component capable of generating a signal based on acceleration. Accelerometer 708 may be a micro electro-mechanical systems (MEMS) device, such as the LIS3L02AS4 3-axis solid state linear accelerometer by STMicroelectronics.

Accelerometer 708 may output voltage values corresponding to the acceleration of centrifuge containment vessel 704 along three axes, e.g., x-, y- and z-axes. The x-axis output voltage of accelerometer 708 may be compared to a first reference voltage at x-axis comparator 710. The y-axis output voltage of accelerometer 708 may be compared to a second reference voltage at y-axis comparator 712. The z-axis output voltage of accelerometer 708 may be compared to a third reference voltage at z-axis comparator 714. The voltage output of comparators 710, 712, and 714 may be added to obtain a sum voltage. Summing comparator 716 may compare the sum voltage to a fourth reference voltage. One or more of the first reference voltage, second reference voltage, third reference voltage and fourth reference voltage can be based on the imbalance tolerance of the centrifuge and may be adjustable. For example, a potentiometer may be adjusted to alter a supply voltage, or a value may be adjusted in software or firmware associated with imbalance sensor 706. The adjustable reference voltage values may allow the imbalance sensor to be adjusted for use with different centrifuges having different imbalance tolerances.

The output of summing comparator 716 may be provided to switch 718. Switch 718 may be, e.g., a field-effect transistor (FET) switch. The output of the switch may be connected to centrifuge 702 such that rotation of centrifuge 702 is discontinued when the state of switch 718 corresponds to an imbalance condition of the centrifuge as indicated by the output of summing comparator 716. In this manner, when acceleration of centrifuge containment vessel 704 as measured along one or more of the x-axis, y-axis and z-axis exceeds the imbalance tolerance threshold of centrifuge 702, rotation of centrifuge 702 can be discontinued. In some embodiments, an alert may be generated based on the output of comparator 710, comparator 712, comparator 714, comparator 716, and/or switch 718. The alert may be a message, light, sound, etc., that may be communicated to a laboratory automation system and/or displayed or emitted by the centrifuge.

One or more of comparators 710, 712, 714, and 716 may be communicatively coupled to a processor. The processor (not shown) may be a processor associated with centrifuge 702, a processor of a laboratory automation system, or a processor of another system or computer. Instructions executed by the processor may be stored on the processor or may be stored in a memory (not shown) accessible by the processor. Switch 718 may be communicatively coupled to a processor. An alert may be generated when the output of one or more of comparators 710, 712, 714, and 716 exceeds a threshold voltage level. In another embodiment, an alert may be generated when a switch 718 is switched to a state resulting in centrifuge 702 shutdown. Such alerts may be transmitted to a laboratory automation system computer such that scheduling of sample processing can be adjusted based on the centrifuge shutdown.

In some embodiments, one or more components of imbalance sensor 706, such as accelerometer 708, comparators 710-716, switch 718, and other associated components, may be mounted on a PCB. The PCB may be mounted to centrifuge containment vessel 704 such that the acceleration of centrifuge containment vessel 704 is transmitted to accelerometer 708.

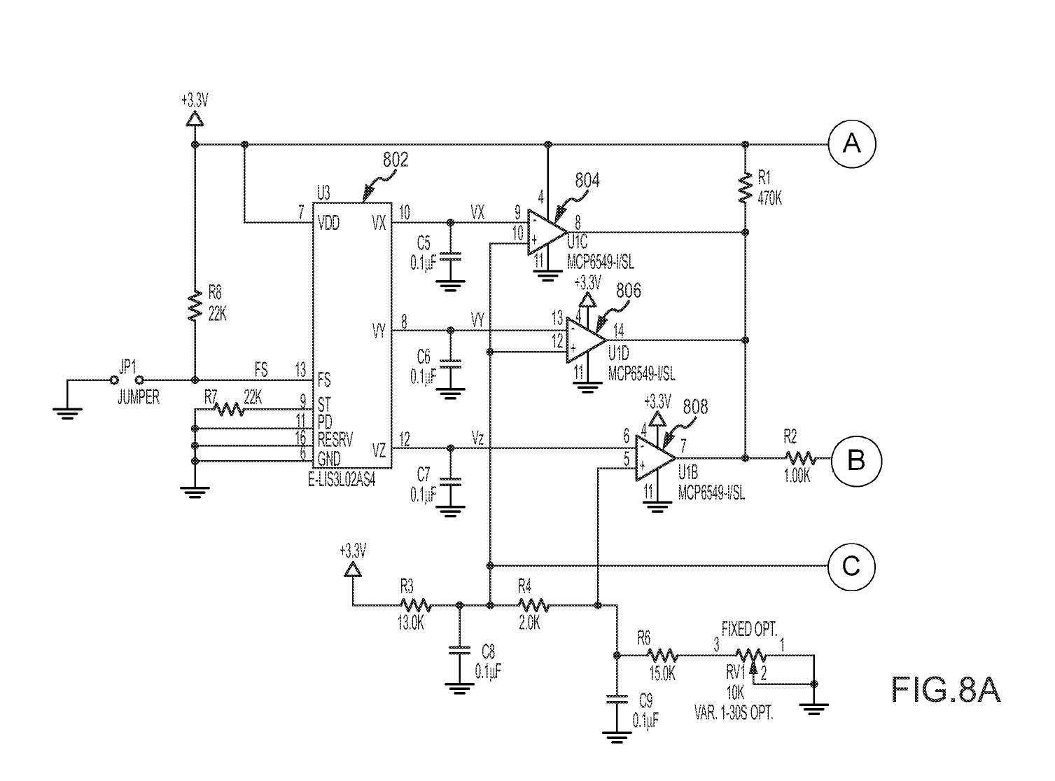

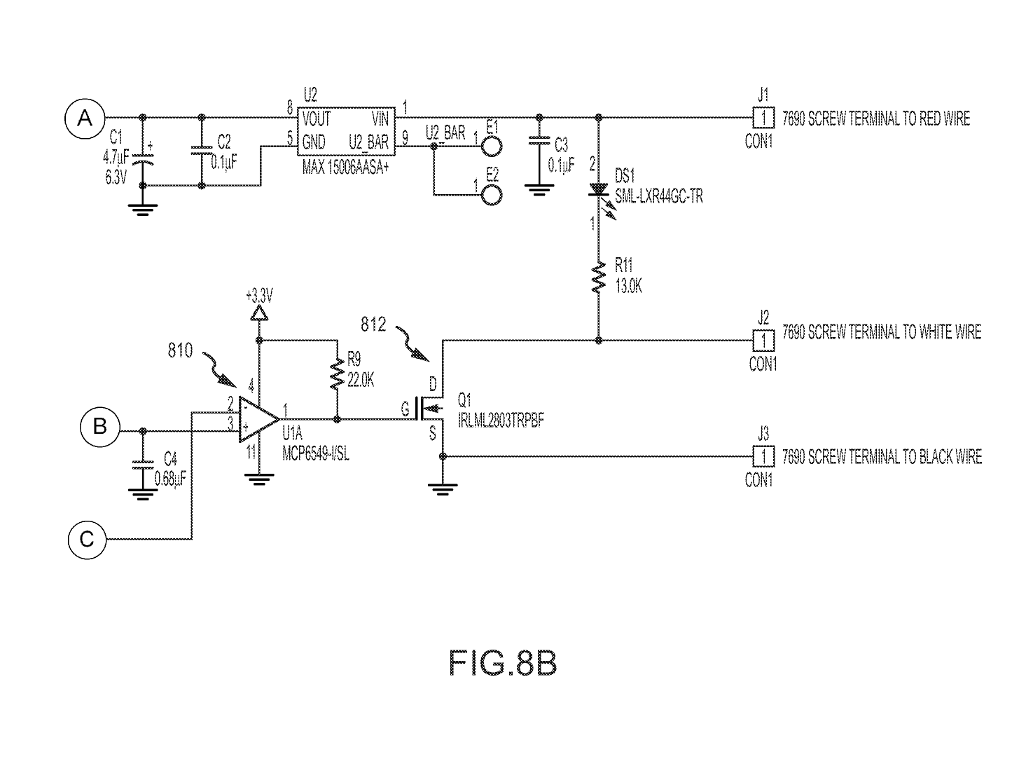

FIG. 8 depicts an illustrative circuit diagram for an accelerometer based centrifuge imbalance sensor. Accelerometer 802 (e.g., accelerometer 708 described with reference to FIG. 7) provides voltage outputs corresponding to acceleration measured along x, y and z axes. The x-axis output is provided to comparator 804 (e.g., comparator 710 described with reference to FIG. 7). The y-axis output is provided to comparator 806 (e.g., comparator 712 described with reference to FIG. 7). The z-axis output is provided to comparator 808 (e.g., comparator 714 described with reference to FIG. 7). The output of comparators 804, 806 and 808 is provided to summing comparator 810 (e.g., comparator 716 described with reference to FIG. 7). The output of summing comparator 810 is provided to switch 812 (e.g., switch 718 describe with reference to FIG. 7).

In some embodiments, the resistors used to regulate one or more of the first reference voltage, second reference voltage, third reference voltage and fourth reference voltage are replaced with a digital to analog converter that allows setting of reference voltage values with software via a user interface. In this manner, the accelerometer based imbalance sensor is easily adaptable to various centrifuges having different imbalance tolerance levels and to accommodate various sample handling requirements. Alternatively, the resistors used to regulate one or more of the first reference voltage, second reference voltage, third reference voltage and fourth reference voltage are replaced with potentiometers to allow manual adjustment of the resistance values.

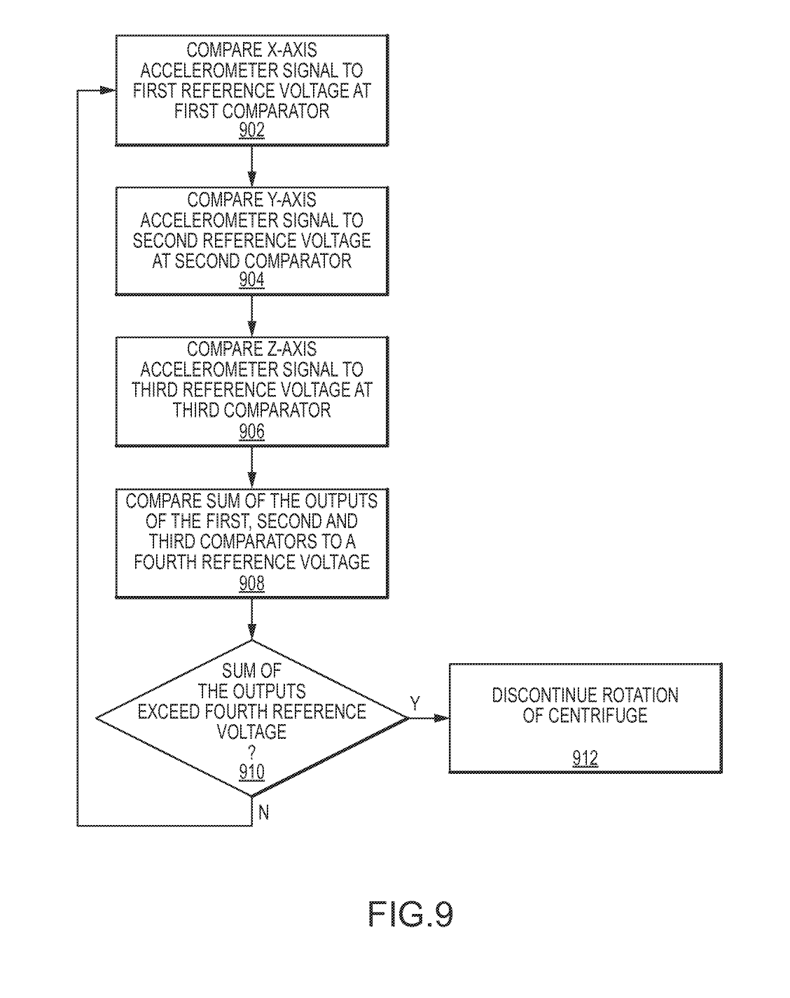

FIG. 9 shows a flow diagram for a centrifuge imbalance sensor coupled to a centrifuge containment vessel 704 for a centrifuge 702. The imbalance sensor can include an accelerometer 708 capable of measuring acceleration along three axes. At operation 902, an x-axis accelerometer signal is compared by a first comparator 710 to a first reference voltage. At operation 904, a y-axis accelerometer signal is compared by a second comparator 712 to a second reference voltage. At operation 906, a z-axis accelerometer signal is compared by a third comparator 714 to a third reference voltage. The sum of the outputs of the first, second and third comparators are compared by a summing comparator 716 to a fourth reference voltage, as indicated at operation 908. The summing comparator 716 determines whether the sum of the outputs exceeds the first reference voltage, as indicated at decision diamond 910. If the sum of the outputs exceeds the fourth reference voltage, the operation of centrifuge 702 can be halted, as indicated at operation 912. For example, the output of the summing comparator may be coupled to a switch 718 configured to discontinue the rotation of centrifuge 702.

### III. Computer Architecture

The various participants and elements described herein with reference to the figures may operate one or more computer apparatuses to facilitate the functions described herein. Any of the elements in the above description, including any servers, processors, or databases, may use any suitable number of subsystems to facilitate the functions described herein, such as, e.g., functions for operating and/or controlling the functional units and modules of the laboratory automation system, transportation systems, the scheduler, the central controller, local controllers, etc.

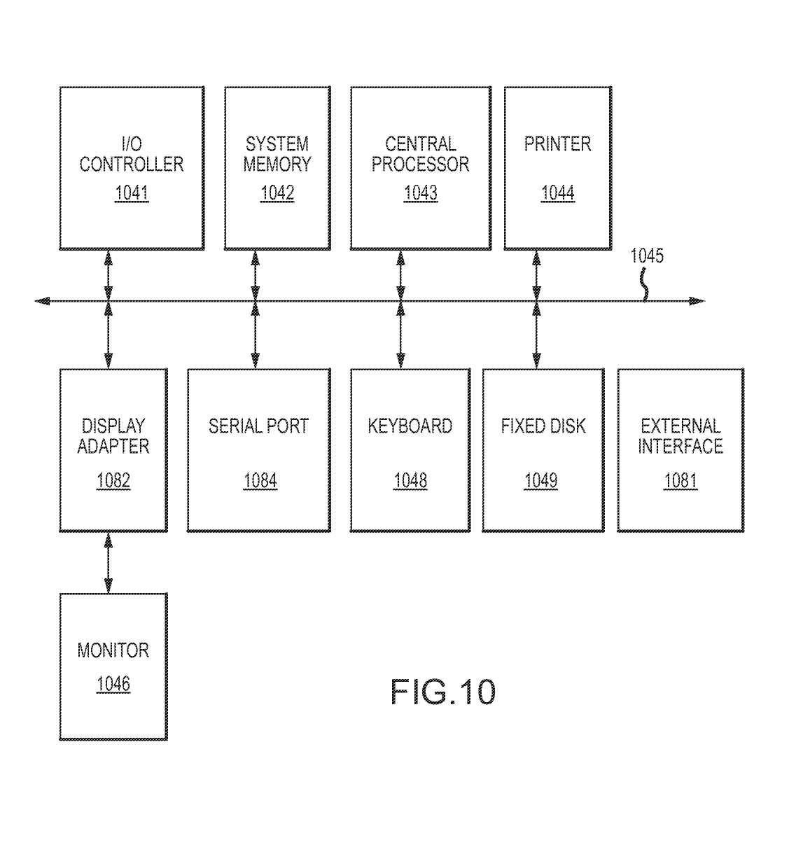

Examples of such subsystems or components are shown in FIG. 10. The subsystems shown in FIG. 10 are interconnected via a system bus 1045. Additional subsystems such as a printer 1044, keyboard 1048, fixed disk 1049 (or other memory comprising computer readable media), monitor 1046, which is coupled to display adapter 1082, and others are shown. Peripherals and input/output (I/O) devices, which couple to I/O controller 1041 (which can be a processor or other suitable controller), can be connected to the computer system by any number of means known in the art, such as serial port 1084. For example, serial port 1084 or external interface 1081 can be used to connect the computer apparatus to a wide area network such as the Internet, a mouse input device, or a scanner. The interconnection via system bus allows the central processor 1043 to communicate with each subsystem and to control the execution of instructions from system memory 1042 or the fixed disk 1049, as well as the exchange of information between subsystems. The system memory 1042 and/or the fixed disk 1049 may embody a computer readable medium.

Embodiments of the technology are not limited to the above-described embodiments. Specific details regarding some of the above-described aspects are provided above. The specific details of the specific aspects may be combined in any suitable manner without departing from the spirit and scope of embodiments of the technology. For example, back end processing, data analysis, data collection, and other processes may all be combined in some embodiments of the technology. However, other embodiments of the technology may be directed to specific embodiments relating to each individual aspect, or specific combinations of these individual aspects.

It should be understood that the present technology as described above can be implemented in the form of control logic using computer software (stored in a tangible physical medium) in a modular or integrated manner. Furthermore, the present technology may be implemented in the form and/or combination of any image processing. Based on the disclosure and teachings provided herein, a person of ordinary skill in the art will know and appreciate other ways and/or methods to implement the present technology using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the technology will become apparent to those skilled in the art upon review of the disclosure. The scope of the technology should, therefore, be determined not with reference to the above description, but instead should be determined with reference to the pending claims along with their full scope or equivalents.

One or more features from any embodiment may be combined with one or more features of any other embodiment without departing from the scope of the technology.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A system for non-contact specimen container characterization, the system comprising:
a processor;
a specimen container diameter sensor communicatively coupled to the processor, the specimen container diameter sensor including a horizontally oriented linear optical array; and
a specimen container length sensor communicatively coupled to the processor, the specimen container length sensor including a vertically oriented linear optical array;
wherein the specimen container diameter sensor and the specimen container length sensor are located in a fixed position relative to a conveyor for transporting a plurality of specimen containers.

2. The system of claim 1, further comprising a cap color sensor communicatively coupled to the processor, wherein the cap color sensor is located in a fixed position relative to the conveyor for transporting a plurality of specimen containers.

3. The system of claim 2, wherein the cap color diameter sensor includes a light-to-frequency converter.

4. The system of claim 1, further comprising a plurality of cap color diameter sensors communicatively couple dot the processor,
wherein each of the plurality of cap color sensors are located in a fixed position relative to the conveyor for transporting a plurality of specimen containers, and
wherein a signal received by the processor from the specimen container length sensor is used to determine which of the plurality of cap color sensors generate a signal corresponding to the cap color of a specimen container cap.

5. The system of claim 1, wherein the specimen container is inserted into a sample carrier that is transported by the conveyor.

6. The system of claim 1, wherein the motion of the conveyor is halted when the specimen container is in a position at which one or more of the specimen container diameter sensor and the specimen container length sensor are capable of obtaining data associated with the specimen container.

7. The system of claim 6, wherein motion of the conveyor is halted based on a signal received by the processor from one or more of the specimen container diameter sensor and the specimen container length sensor.

8. A method for non-contact specimen container characterization, the method comprising, by a processor:
receiving a first signal from a specimen container diameter sensor, the specimen container diameter sensor including a horizontally oriented linear optical array;
receiving a second signal from a specimen container length sensor, the specimen container length sensor including a vertically oriented linear optical array;
determining a specimen container diameter based on the first signal; and
determining a specimen container length based on the second signal.

9. The method of claim 8, further comprising receiving a third signal from a cap color sensor and determining a specimen container cap color based on the third signal.

10. The method of claim 8, further comprising determining, based on the second signal, which of a plurality of cap color sensors to read for determining a container cap color.

11. The method of claim 8, further comprising determining, based on the first signal, when to generate an instruction for halting a conveyor that transports the specimen container.

12. An imbalance sensor for detecting centrifuge imbalance, the imbalance sensor comprising:
an accelerometer coupled to a centrifuge containment vessel;
a comparator configured to compare an acceleration output of the accelerometer with a reference voltage level; and
a switch configured to receive an output from the comparator; wherein the rotation of the centrifuge rotor is discontinued based on the output of the switch.

13. An imbalance sensor for detecting centrifuge imbalance, the imbalance sensor, comprising:
an accelerometer coupled to a centrifuge containment vessel;
a first comparator configured to compare accelerometer output corresponding to a first axis with a first voltage level;
a second comparator configured to compare accelerometer output corresponding to a second axis with a second voltage level.

14. The imbalance sensor of claim 12, further comprising:
a third comparator configured to compare accelerometer output corresponding to a third axis with a third voltage level;
a summing comparator configured to:
receive a first output from the first comparator, a second output from the second comparator and a third output from the third comparator; and
compare, by a summing comparator, a sum of the first output, the second output and the third output to a fourth voltage level.

15. The imbalance sensor of claim 14, wherein one or more of the first voltage level, second voltage level, third voltage level, and fourth voltage level is an adjustable reference level.

16. The imbalance sensor of claim 14, wherein one or more of the first comparator, the second comparator, the third comparator and the summing comparator is communicatively coupled to a processor, and wherein an alert is generated by the processor based on the output of one or more of the first comparator, the second comparator, the third comparator and the summing comparator.

17. The imbalance sensor of claim 14, wherein the switch is communicatively coupled to a processor, and wherein an alert is generated by the processor based on the state of the switch.

18. The imbalance sensor of claim 14, further comprising a switch configured to receive an output from the first comparator; wherein an imbalance state of a centrifuge is determined based on the output of the switch.

19. A method for detecting centrifuge imbalance, the method comprising:
coupling an accelerometer to a centrifuge containment vessel;
comparing, by a first comparator, an accelerometer output corresponding to a first axis with a first voltage level;
comparing, by a second comparator, an accelerometer output corresponding to a second axis with a second voltage level;
comparing, by a third comparator, an accelerometer output corresponding to a third axis with a third voltage level;
receiving, by a summing comparator, a first output from the first comparator, a second output from the second comparator and a third output from the third comparator
comparing, by the summing comparator, a sum of the first output, the second output and the third output to a fourth voltage level; and
when the sum of the first output, the second output and the third output exceed the fourth voltage level, discontinuing the rotation of a centrifuge.

20. The method of claim 19, further comprising adjusting at least one of the first voltage level, the second voltage level, the third voltage level, and the fourth voltage level based on imbalance tolerance of the centrifuge.

21. The method of claim 19, further comprising generating an alert based on at least one of the first output, the second output, the third output and an output of the summing comparator.
